(19) United States
(12) Patent Application Publication
(10) Pub. No.: US 2009/0029480 A1
(43) Pub. Date: Jan. 29, 2009

(54) Testing device

(76) Inventor: Christian James Loane, Western Australia (AU)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/883,115

(22) PCT Filed: Jan. 25, 2006
(86) PCT No.: PCT/AU06/00090

§ 371 Date: Jun. 11, 2008

(30) Foreign Application Priority Data
Jan. 25, 2005 (AU) 2005100056
Jan. 26, 2005 (AU) 2005100063
Jan. 26, 2005 (AU) 2005100064
Apr. 21, 2005 (AU) 2000510335
Apr. 21, 2005 (AU) 2005100334
Aug. 5, 2005 (AU) 2005100636
Sep. 22, 2005 (AU) 2005905226
Oct. 24, 2005 (AU) 2005905871

(51) Int. Cl. G01N 21/78; G01N 31/22; B05D 3/02

(52) U.S. Cl. 436/170; 422/82.05; 422/56; 427/372.2

(57) ABSTRACT

A device for testing for the presence of an analyte, the device comprising at least one reagent adapted to provide a calorimetric indication in the presence of the analyte, a catalyst to catalyse the reaction providing the calorimetric indication, and where there is provided one reagent, means for substantially inhibiting reaction between reagent and catalyst or where there is provided more than one reagent, means for substantially inhibiting reaction between said reagents and between said reagents and catalyst, prior to introduction of the analyte, wherein the at least one reagent and the catalyst are solids.

### FIELD OF THE INVENTION

The present invention relates to a device for testing for the presence of an analyte, a method for preparing a device for testing for the presence of an analyte and a method for performing a test for the presence of an analyte.

### BACKGROUND ART

In today's world of greater threat from terrorism and in particular, attacks involving explosives or biological material, devices capable of detecting residues in clandestine laboratories and on surfaces or articles contacted with residues are of great importance.

For years, detection devices have employed the use of various reagent chemicals to give a discernable and known colorimetric indication in the presence of resides of interest such as explosives or biological materials. The reagents used in, for example the calorimetric identification of residue analytes are, in general, hazardous liquids and solvents. The majority of wet chemical colorimetric reactions require the use of one or more extremely acidic or alkaline reagents to catalyse the colorimetric indication. In general, a given liquid reagent has a greater capacity to drive a reaction compared to a solid reagent with similar chemical properties. Thus, kits utilise liquid reagents as these generally offer greater sensitivity for the analyte of interest because the liquid reagent is capable of driving the reaction at lower analyte concentrations. However, the use of liquid reagents creates problems in relation to manufacturing, packaging, handling and transportation of kits.

Due to the hazardous nature of the liquid reagents, transportation of detection kits may be illegal unless stringent hazard prevention measures are adhered to. This is generally achieved by the use of reinforced packaging. Such packaging poses problems with respect to cost and also final handling. For example, often, the operator must physically break glass ampoules of corrosive acids which poses dangers to the operator, as well as creating issues in relation to the disposal of the bulky waste, and increases in cost and analysis time.

In addition to the use of potentially dangerous liquid reagents, prior art devices utilise multi-step reaction sequences for the partial identification of individual analytes. They are cumbersome and a large amount of manual handling is necessary to perform the required tests as either numerous reagents are necessary, or analytes require liquid extraction prior to analysis, or individual aerosol spray reagents need to be pre-mixed prior to reaction. All these multi-step sequences are employed to enable greater shelf life storage and viability of the kit and enhance sensitivity and selectivity for individual analytes.

An example of potential analytes are explosives and their residues which can be divided into several broad categories:
1. Nitroaromatics—including 2,4,6-TNT, trinitrobenzene, picric acid and its derivatives, and tetryl (N-methyl-N,2,4,6-tetranitroaniline, also known as tetralite).
2. Nitramines—RDX (Royal Demolition Explosive or Research Department Explosive; hexahydro-1,3,5-trinitro-1,3,5 triazine, also known as cyclonite), HMX (HMX (high melting explosive; octahydro-1,3,5,7-tetranitro-1,3,5,7 tetrazocine, also known as octogen); and
3. Nitrate esters—dynamite, nitroglycerine EGDN (ethylene glycol dinitrate), PETN (pentaerythritol tetranitrate, C₅H₈N₄O₁₂);
4. Nitrates—contaminants or constituents of crude explosives such as ammonium nitrates fuel oil (ANFO) and flash powders.
5. Oxidisers—(a) contaminants or constituents of crude explosives such as chlorates, iodates, bromates. (b) Peroxides—such as triacetonetriperoxide (TATP) and acetylperoxide.

Prior art test kits relating to the detection of explosive materials, including but not limited to the above (1-5) all incorporate at some point: (a) solvents e.g. alcohols, acetone, dimethylsulfoxide, (b) hazardous materials e.g. sulphuric, hydrochloric, phosphoric acids (c) corrosive alkaline solutions e.g. sodium and potassium hydroxides and (d) other liquid or hazardous chemicals. These reagents and their reaction mixtures require special packaging such as light and shock resistant ampoules and plastic or glass bottles. The methodologies of existing testing kits and prior art literature all requires multi-step reaction sequences for detection of all classes of explosives.

Known biothreat test kits are based upon immunoassay-based targeting of individual threat organisms, which is complex, slow and expensive (e.g. culturing, plate counting, microscopy, PCR, mass-spectroscopy, etc.). The kits are based on indirect multi-step reaction sequences (e.g. bioluminescence, fluorescence quenching, metabolite or bacterial-metabolite complex colorimetric detection), and require hazardous liquid reagents in multi-component packaging. Of the prior art non-immunoassay based colorimetric tests disclosed, all fail to mention how the dry reagent chemicals are “dry impregnated and stabilised” into bibulous carriers.

Ricin is a complex protein, extracted directly from the castor bean or from the “wet mash” by-product produced by crushing and extracting castor oil from Ricinus Communis. Clandestine ricin extracts also contain the alkaloid Ricinine, a natural biomarker for the presence of the ricin protein.

In addition to testing for explosives, explosive residues and biological agents, there are instances where testing for alcohols and in particular ethanol is required. For example, there are instances such as in schools and prisons where the ‘spiking’ of drinks with ethanol occurs.

Whilst dry chemical colorimetry is known, direct one-for-one replacement of all wet reagents and solvents for dry alternatives is not always possible, as often there is simply no equivalent reagent in dry form. The most important factors to consider when developing a colorimetric device from a technical view point are:
the chemicophysical properties of the original wet reagents such as liquids, low melting point solids and hygroscopic solids;
the choice of alternative dry reagent; and
degradation of the dry reagents.

Reagent degradation is of particular importance in the preparation of dry calorimetric devices due to the fact that only minute quantities of the active ingredients are present within a given device. Loss of even small percentages of active materials from the device dramatically reduces sensitivity for the analyte. Degradation of reagents will greatly reduce long term shelf life and viability of the device. The three main causal factors of reagent degradation are (i) reaction between co-reagents within the device, and (ii) reaction between water and reagents and (iii) UV degradation.

Water molecules are attracted and bound to solid chemicals based on hydrogen and covalent bonding potential of the solid chemical species which varies greatly between solid reagents. The hygroscopic influence gives rise to two important problems in dry calorimetric chemistry. Firstly, the introduced water may induce reaction with one or all solid reagents present, leading ultimately to viability degradation. Secondly, the introduction of water into the device may destroy it aesthetically, which is unacceptable in a long term storage single use commercial item.

Prior art dry test kits require the use of air and water tight packaging to avoid reagent degradation. On exposure to the environment, such devices can rapidly degrade via reaction with water or initiation by UV light.

There is a need for a dry pack which offers sensitivity toward biological materials, explosive materials or alcohols, providing a rapid and discernable presumptive colorimetric indication. Further, it would be highly advantageous if not only the multi-step reaction sequences of prior art tests be removed, but also both the hazardous liquid reagents and cumbersome packaging (e.g. breakable ampoules and glass bottles).

The preceding discussion of the background to the invention is intended to facilitate an understanding of the present invention. However, it should be appreciated that the discussion is not an acknowledgement that any material referred to was part of the common general knowledge in Australia as at the priority date of the application.

Throughout the specification, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

In accordance with the present invention, there is provided a device for testing for the presence of an analyte, the device comprising at least one reagent adapted to provide a colorimetric indication in the presence of the analyte, a catalyst to catalyse the reaction providing the calorimetric indication, and where there is provided one reagent, means for substantially inhibiting reaction between reagent and catalyst or where there is provided more than one reagent, means for substantially inhibiting reaction between said reagents and between said reagents and catalyst, prior to introduction of the analyte, wherein the at least one reagent and the catalyst are solids.

Advantageously, the device of the present invention provides a means for the presumptive identification of specific analytes without the use of hazardous liquid chemicals.

The device may be provided in the form of a pressed article such as a tablet or at least one dry coated solid support upon which the calorimetric reaction can take place, wherein the solid support may be provided in the form of paper, fabric, plastic, silicates, alumina based products or wood. In one form of the invention, the solid support may act as a wick and may be provided in the form of normal and reverse phase filter paper, glass and ceramic fibre paper, nylon, cotton and rayon.

Preferably, the means for substantially inhibiting the reaction between reagent and catalyst or where there is provided more than one reagent, between said reagents and between said reagents and catalyst, prior to introduction of the analyte comprises physical separation of each reagent from each other and/or the or each reagent and the catalyst.

In one form of the invention, the physical separation is provided in the form of an encapsulating substance that substantially separately encapsulates each reagent and the catalyst, thereby substantially preventing reaction. The encapsulating substance may be selected from but not limited to polyvinyl alcohol, polyvinyl pyrollidinone, acrylics, styrene, vinyl chloride, natural gums, gelatine, and waxes of various chain lengths and their salts. Preferably, the encapsulating substance is selected from stearic acid and magnesium stearate. Reagents and catalysts once incorporated within the encapsulation material may be extruded into sheets or pressed into tablets.

In a second form of the invention, the physical separation comprises the use of more than one dry impregnated bibulous carrier wherein the at least one reagent and the catalyst are provided on different impregnated bibulous carriers. The carriers may be aligned end to end to provide a consecutive lateral flow sequence or overlayed one on top of another in a sandwich fashion, such that separation of said reagents and catalysts is maintained until the application of the analyte. On application of the analyte in liquid form, the wicking process results in mixing of the reagents, catalyst and analyte.

Where the device comprises more than one dry impregnated bibulous carrier, the device preferably comprises an encapsulating substance that substantially separately encapsulates each reagent and the catalyst.

In a third form of the invention, where the solid support is provided in the form of a crystalline lattice, the distribution of the at least one reagent and the catalyst amongst the lattice interstices substantially inhibits their reaction.

Where the device comprises a solid support in the form of a crystalline lattice, the device preferably comprises an encapsulating substance that substantially separately encapsulates each reagent and the catalyst.

Preferably, the device further comprises agents adapted to reduce UV degradation such as micronised zinc and titanium oxides, octyl-methoxycinnamate, butyl methoxydibenzoylmethane and octyl-salicylate. Advantageously, said reagents may also increase the hydrophobicity of the device.

The device may further comprise means for introducing the analyte to at least one reagent. In one form of the invention, the means for introducing the analyte to at least one reagent is provided in the form of a swab. The swab may be composed of any material that will assist in the transfer of the analyte to the device, but adsorbent materials such as cotton or rayon are preferred. The swab may be dry or may comprise any solvent that will assist in the transfer of the analyte to the device such as water, alcohols or other organic solvents. It should be appreciated that more than one solvent may be provided. Where the device comprises an encapsulating substance, the solvent preferably dissolves the encapsulating substance. Where the encapsulating substance is stearic acid, the solvent is preferably dimethylsulfoxide. Without being limited by theory, it is believed that the use of co-solvents such as chloroform and acetone may assist in evaporation of the solvent which may increase the colorimetric reaction and enhances sensitivity. Where the device is provide on a bibulous carrier, the solvent should be able to run along the support surface.

The device may further comprise inert dry chemicals with detergent properties to enhance the mixing of the analyte with the at least one reagent. Without being limited by theory, it is believed that such chemicals may assist in either lysing and solubilising cells/macromolecules allowing interaction with the at least one reagent or solubilising of aqueous insoluble materials, of which many explosive materials are, thus enabling them to contact more readily the aqueous soluble dry reagents. The detergent may be provided in the form of sodium lauryl sulphate.

Preferably, the device is stored in a moisture and UV resistant package prior to use. It will be appreciated that similar packaging to that used in the food, medical, and diagnostic industries which require UV, gas-exchange, and moisture proof packaging such as triple ply nylon, mylar and aluplas products may be appropriate.

The device may additionally comprise desiccants, inert gas packaging and vacuum sealing to further inhibit the ingress of moisture. Where the device is provided with a desiccant, the desiccant may be provided in the form of anhydrous sodium sulphate or silicates.

The device may be provided with bulking agents which may be advantageous when the device is provided in the form of a tablet. The bulking agent may act as a filler and/or a binder. Advantageously, the bulking agent may act as a solid means of diluting the at least one reagent, thereby enabling minute amounts of the at least one reagent to be retained in the device. The bulking agent may further assist in maintaining the shape of a pressed article.

Where the device is provided with a bulking agent, the bulking agent may be selected from the group comprising sodium lauryl sulphate, sulphated primary alcohols, methyl cellulose, carboxy methyl cellulose and natural inert gums. Advantageously, the bulking agent may absorb any residual moisture.

The device may be provided with a drying agent adapted to further inhibit ingress of water. Where the device is provided with a drying agent, the drying agent may be selected from the group comprising anhydrous sodium sulphate, methylcellulose and calcium hydroxide.

The colorimetric reaction may be observed in any part of the electromagnetic spectrum.

The device of the present invention may be used to detect the presence of explosives and explosive residues, materials composed of proteinaceous residues and fingerprint functional groups as biomarkers of biological agents and alcohols.

Where the device is used to detect the presence of explosives and explosive residues, the explosives and explosive residues may be selected from the group comprising nitramines, nitrates, nitrate esters, nitroaromatics and oxidising agents such as chlorates, bromates, iodates and peroxides.

Where the device is used to detect the presence of alcohols, the device is preferably used to detect the presence of ethanol.

It should be appreciated that the reagents and catalysts employed depend on the target analyte. Where the analyte is a nitramine or a nitrate, the reagent may be selected from the group comprising analine sulphate, barium chloride, brucine, cupric-tetrapyridine, diphenylamine, griess reagent, J-Acid, K-Acid, I-Acid, Nitron, mercuric chloride, methylene blue, silver nitrate, dithiocarbamate, thymol blue, anthranilic acid, alphanaphthylamine, sulphanilic acid, sulphanilamide, p-aminobenzoic acid, N-(1-naphthyl)ethylenediamine dihydrochloride, sodium arsenite, picric acid, p-anisidine, o-anisidine, diphenylhydrazine, dimethylaminobenzaldehyde, diethylaminobenzaldehyde, dimethylamino cinnamaldehyde and sodium salicylate. The reagent preferably comprises about 1-30% w/w of the device.

Where the analyte is a nitroaromatic, the reagent may be selected from the group comprising potassium hydroxide, calcium hydroxide, tetra-alkyl ammonium hydroxide, sodium hydroxide and diphenylamine. The reagent preferably comprises about 1-30% w/w of the device.

Where the analyte is an oxidising agent such as chlorate, bromate, iodate and peroxide, the reagent may be selected from the group comprising indigo carmine, N,N′-diphenylbenzidine, phenylanthranilic acid, methylene blue, potassium iodide, aniline hydrochloride, aniline sulphate, aniline acetate, aniline nitrate, brucine sulphate, J-Acid, K-Acid, ammoniumthiocyanate, zinc chloride, thiodene, fluorescein, potassium iodide, potassium bromide, safranin, thallous hydroxide, manganous sulphate, diphenylamine, o-toluidine, ferrous thiocyanate N,N-diethyl-1,4-phenylene diamine sulfate, ferroin (aqueous solution of ferrous sulfate heptahydrate and 1,10-phenanthroline monohydrate), diphenylamine-4-sulfonic acid barium salt and cresyl violet acetate (9-amino-5-imino-5H-benzo(a) phenoxazine. The reagent preferably comprises about 1-30% w/w of the device.

Where the analyte is a proteinaceous residue or a fingerprint functional group as a biomarker of a biological agent, the reagent may be selected from the group comprising dimethylaminobenzaldehyde, diethylaminobenzaldehyde, dimethylaminocinnamaldehyde, p-hydroxydiphenyl, anthrone, ninhydrin, lowery, bradford, BCA/biuret and coomassie blue reagents, methylene violet, crystal violet, safranine, acid black, 1,8-diaza-9-fluorenone, 1,2-indanedione, gentian violet, sudan black, rhodamine 6 g, safranin o, nile red, acid fuschin, genipin. The reagent preferably comprises about 1-30% w/w of the device.

Where the analyte is ricin, the device tests for the presence of ricinine, a biomarker for ricin and the reagent may be provided in the form of a pH indicator and selected from the group comprising, universal indicator, thymol blue, metacresol purple, bromocresol purple, chlorophenol red, p-nitrophenol, Alizarin, bromothymol blue, brilliant yellow, phenol red, neutral red, m-nitrophenol, cresol red, curcumin, metacresol purple, bromocresol red, rosalic acid, quinoline blue, resorcin blue, alizarin red s and methyl red.

Where the analyte is an alcohol and preferably ethanol, the reagent may be selected from the group comprising vanadium oxinate, nitratocerate, 4-(phenylazo)phenylhydrazinosulfonic acid, nitrophenylhydrazine, fuschin, malachite green, sodium nitroprusside, proline, odianisidine, p-hydroxydiphenyl, o-hydroxydiphenyl, ceric ammonium nitrate, m-phenylenediamine hydrochloride, hydroquinone and sulfanilic acid and any secondary aliphatic amine.

The catalyst may be an acid catalyst, an alkaline catalyst or an oxidising agent, the choice of catalyst depending on the colorimetric reaction. Where the catalyst is an acid catalyst, the catalyst may be selected from the group comprising sodium bisulphate, ammonium bisulphate, trichloroacetic acid, trifluoroacetic acid, oxalic acid, citric acid, tartaric acid, ammonium chloride, sulphuric acid and phosphoric acid.

Where the catalyst is an alkaline catalyst, the catalyst may be selected from the group comprising sodium hydroxide, potassium hydroxide, calcium hydroxide, tetra-alkylammonium hydroxide and diphenylamine.

Where the analyte is an alcohol and preferably ethanol, the catalyst is preferably an oxidising agent, and may be selected from the group comprising potassium dichromate and potassium permanganate.

It should be appreciated that whilst the choice of catalyst will depend on the analyte, more than one catalyst may be used to catalyse a particular colorimetric reaction. Where more than one catalyst is used, the combination of catalysts may comprise an acid catalyst and an oxidising catalyst. Alternatively, the combination of catalysts may comprise an acid catalyst, an alkaline catalyst and an oxidising agent.

Where the analyte is a nitramine or a nitrate, the device may further comprise a reducing agent which may be selected from the group comprising nano-sized zinc powder, thiosulphate salts, metabisulphite salts, ascorbic acid, stannous chloride, titanium trichloride, copperised-cadmium and ferrous sulphate.

Where the device is provided in the form of a tablet, the use of stearic acid and sodium lauryl sulphate are believed to assist in tablet pressing and the maintenance of the shape of the tablet.

In accordance with the present invention, there is provided a method for preparing a device for testing for the presence of an analyte, the method comprising the steps of:
mixing at least one reagent adapted to provide a colorimetric indication in the presence of the analyte, a catalyst to catalyse the reaction providing the calorimetric indication, and an encapsulating substance adapted to substantially inhibit reaction between reagent and catalyst where there is provided one reagent, or where there is provided more than one reagent, between said reagents and between said reagents and catalyst, prior to introduction of the analyte, wherein the at least one reagent, the catalyst and the encapsulating substance are solids, to provide a solid mixture; and
forming said mixture into a pressed article.

Preferably, the method comprises the further step of:
milling the at least one reagent, the catalyst and the encapsulating substance prior to the step of pressing said mixture into a tablet.

Preferably, the step of milling the at least one reagent, the catalyst and the encapsulating substance prior to the step of pressing said mixture into a tablet comprises the additional step of;
milling the at least one reagent, the catalyst and the encapsulating substance such that the particles of the at least one reagent, the catalyst and the encapsulating substance are micron sized.

Preferably, the step of milling the at least one reagent, the catalyst and the encapsulating substance prior to the step of pressing said mixture into a tablet further comprises the step of:
milling the at least one reagent, the catalyst and the encapsulating substance separately prior to forming the mixture.
   Preferably, the method comprises the further step of:
reducing exposure of the mixture to light.

Preferably, the method comprises the further step of:
reducing exposure of the mixture to moisture.

The step of reducing exposure of the mixture to moisture maybe performed by any method known in the art including the use of humidity and temperature controlled rooms and the use of inert gas flows over the instrumentation.

Preferably, the at least one reagent, the catalyst and the encapsulating substance are dried before use.

Preferably, the method comprises the further step of:
mixing a bulking agent with the at least one reagent, the catalyst and the encapsulating substance.

Preferably, the method comprises the further step of:
packaging the device in a moisture and UV resistant package.

Preferably, the step of packaging the device in a moisture and UV resistant package comprises the step of:
reducing exposure of the device to moisture.

Preferably, the step of reducing exposure of device to moisture comprises packaging the device in the presence of an inert atmosphere.

In accordance with the present invention, there is provided a method for preparing a device for testing for the presence of an analyte, the method comprising the steps of:
suspending or dissolving at least one reagent adapted to provide a colorimetric indication in the presence of the analyte, a catalyst to catalyse the reaction providing the calorimetric indication, and an encapsulating substance adapted to substantially inhibit reaction between reagent and catalyst where there is provided one reagent, or where there is provided more than one reagent, between said reagents and between said reagents and catalyst, prior to introduction of the analyte, in a non-aqueous solvent;
introducing a solid support article into the non-aqueous solvent, and
removing the solid support and drying the solid support, thereby producing a dry reagent coated article.

Preferably, the non-aqueous solvent is selected from chloroform, acetone, ether and ethyl acetate.

Preferably, the solid support article is provided in the form of paper, plastic or wood.

Preferably, the method comprises the further step of:
reducing exposure of the device to light.

Preferably, the method comprises the further step of:
reducing exposure of the at least one reagent, the catalyst, the encapsulating substance and the non-aqueous solvent to moisture.

Preferably, the method comprises the further step of:
drying the non-aqueous solvent prior to the step of suspending or dissolving the at least one reagent, the catalyst and the encapsulating substance in the non-aqueous solvent.

The non-aqueous solvent may be dried by any method known in the art including anhydrous sodium sulphate, molecular sieves, sodium wire and by azeotropic distillation.

Preferably, the method comprises the further step of:
packaging the device in a moisture and UV resistant package.

Preferably, the step of packaging the device in a moisture and UV resistant package comprises the further step of:
reducing exposure of the device to moisture.

Preferably, the step of reducing exposure of the device to moisture comprises packaging the device in the presence of an inert atmosphere.

In accordance with the present invention, there is provided a method for using a device for testing for the presence of an analyte, the method comprising the steps of:
transferring an analyte from a surface to the device;
rubbing the analyte onto the surface of the device
   thereby facilitating a colorimetric reaction between at least one reagent wherein the device comprises at least one reagent adapted to provide a colorimetric indication in the presence of the analyte, a catalyst to catalyse the reaction providing the calorimetric indication and where there is provided one reagent, means for substantially inhibiting reaction between reagent and catalyst or where there is provided more than one reagent, means for substantially inhibiting reaction between said reagents and between said reagents and catalyst prior to introduction of the analyte, wherein the at least one reagent and the catalyst are solids to provide a solid mixture.

Preferably, the step of transferring the analyte from a surface to the device comprises the steps of:
rubbing the surface with a swab, thereby transferring at least a portion of the analyte from the surface to the swab; and
rubbing the swab onto the surface of the device, thereby transferring the analyte onto the device.

The analyte may be in a liquid or solid state.

Preferably, the swab comprises a solvent that will assist in the transfer of the analyte to the device such as water, alcohols or other organic solvents. It should be appreciated that more than one solvent may be provided. Where the device comprises an encapsulating substance, the solvent preferably dissolves the encapsulating substance. More preferably, the solvent dissolves the analyte, the at least one reagent and the catalyst.

Preferably, the means for substantially inhibiting reaction between reagent and catalyst or where there is provided more than one reagent, means for substantially inhibiting reaction between said reagents and between said reagents and catalyst is provided in the form of an encapsulating substance and the encapsulating substance is soluble in the solvent.

Preferably, the step of rubbing the swab onto the surface of the device, thereby transferring the analyte onto the device, causes abrasion which may remove the inhibiting means, thereby exposing dry reagents and catalyst to collected sample thus enabling mixing, reaction and a presumptive calorimetric indication for explosive materials.

In accordance with the present invention, there is provided a method for preparing a device for testing for the presence of an analyte, the method comprising the steps of:
suspending or dissolving at least one reagent adapted to provide a calorimetric indication in the presence of the analyte in a first solvent to provide a first solution;
introducing a first solid support article into said first solution;
removing said first solid support and drying, thereby producing a dry reagent coated article;
suspending or dissolving a catalyst to catalyse the reaction providing the calorimetric indication in a second solvent to provide a second solution;
introducing a second solid support article into said second solution,
removing said second solid support and drying, thereby producing a dry catalyst coated article;
attaching the reagent coated article and the catalyst coated article to a support such that the reagent coated article and the catalyst coated article are not touching each other; and
coating the support and the reagent coated article and the catalyst coated article with a moisture resistant coating such that a portion of the catalyst coated article is exposed to the atmosphere.

Preferably, the reagent is provided in the form of a pH indicator.

Preferably, the non-aqueous solvent is selected from chloroform, acetone, ether and ethyl acetate.

Preferably, the solid support article is provided in the form of paper, plastic or wood.

Preferably, the method comprises the further step of:
reducing exposure of the device to light.

Preferably, the method comprises the further step of:
reducing exposure of the at least one reagent, the catalyst, the encapsulating substance and the non-aqueous solvent to moisture.

Preferably, the method comprises the further step of:
drying the non-aqueous solvent prior to the step of suspending or dissolving the at least one reagent, the catalyst and the encapsulating substance in the non-aqueous solvent.

The non-aqueous solvent may be dried by any method known in the art including anhydrous sodium sulphate, molecular sieves, sodium wire and by azeotropic distillation.

Preferably, the step of reducing exposure of the device to moisture comprises packaging the device in the presence of an inert atmosphere.

Preferably, the method comprises the further step of:
packaging the device in a moisture and UV resistant package.

Preferably, the method comprises the further step of:
reducing exposure of the at least one reagent, the first solvent, the catalyst, and the second solvent to moisture.

In accordance with the present invention, there is provided a method for using a device for testing for the presence of an analyte, wherein the device comprises at least one solid reagent adapted to provide a colorimetric indication in the presence of the analyte on a first solid support article, a catalyst to catalyse the reaction providing the colorimetric indication on a second solid support article and the reagent coated article and the catalyst coated article are attached to a support such that the reagent coated article and the catalyst coated article are not touching each other and the support and the reagent coated article and the catalyst coated article are coated with a moisture resistant coating such that a portion of the catalyst coated article is exposed to the atmosphere, the method comprising the steps of:
transferring an analyte from a surface to the atmosphere exposed portion of the catalyst coated article of the device;
rubbing the analyte onto said exposed portion surface of the device,
   thereby facilitating a reaction between the analyte and the catalyst to produce a product whereby said product reacts with the at least one reagent to provide a calorimetric indication.

Preferably, the swab comprises a solvent that will assist in the transfer of the analyte to the device such as water, alcohols or other organic solvents. It should be appreciated that more than one solvent may be provided. Where the device comprises an encapsulating substance, the solvent preferably dissolves the encapsulating substance. More preferably, the solvent dissolves the analyte, the at least one reagent and the catalyst.

Preferably, the step of rubbing the swab onto the surface of the device, thereby transferring the analyte onto the device, causes abrasion which may remove the inhibiting means, thereby exposing dry reagents and catalyst to collected sample thus enabling mixing, reaction and a presumptive colorimetric indication for explosive materials.

The device of the present invention preferably comprises a simple cotton swab (pre-packaged dry or pre-wetted with water, alcohol or other organic solvent) used to collect suspicious residue (solid or liquid) and rubbed onto surface of said device, facilitating a calorimetric indication. Said rubbing on device surface causes abrasion, which removes the moisture/UV protective coat exposing dry reagent chemical to collected sample thus enabling mixing, reaction and a presumptive colorimetric indication for biomass/cellular macromolecules.

Advantageously, the device of the present invention;
1. reduces the use of and exposure to hazardous reagents, i.e. human and environmental exposure during manufacture, use and disposal;
2. reduces the physical dimensions of a testing device appropriate for in-situ use such as use in biosuit; and
3. is robust, easily transportable and simple to use by untrained personnel.

### BRIEF DESCRIPTION OF THE DRAWINGS

The device of the present invention will now be described, by way of example only, with reference to ten embodiments thereof and the accompanying drawing, in which:—

FIG. 1 is an exploded side view of a kit for testing for the presence of explosives and explosive residues in accordance with the present invention;

FIG. 2 is a perspective view of a kit for testing for the presence of explosives and explosive residues in accordance with the present invention;

FIG. 3 is a top view of a kit for testing for the presence of explosives and explosive residues in accordance with the present invention;

FIG. 4 is an exploded side view of a device for testing for the presence of ricin in accordance with the present invention; and

FIG. 5 is a top view of a kit for testing for the presence of alcohol in accordance with the present invention.

### BEST MODE(S) FOR CARRYING OUT THE INVENTION

Those skilled in the art will appreciate that the invention described herein is amenable to variations and modifications other than those specifically described. It is to be understood that the invention includes all such variations and modifications. The invention also includes all of the steps, features, compositions and compounds referred to or indicated in the specification, individually or collectively and any and all combinations or any two or more of the steps or features.

All milling was performed in a ball mill sufficient to produce micronised particles. Milling time was dependent on the amount of material being milled sufficient to produced homogenised micronised materials.

All tablets were prepared in a tablet press. Milled powders were fed via a hopper into a dye and a tablet formed under approximately 5 tonne pressure with a tablet punch.

A kit for the testing of explosives and explosive residues may comprise three tablets, for testing for the presence of oxidising agents such as chlorates, bromates, iodates and peroxides, nitramines/nitrates/nitrate esters and nitro aromatics and as well as comprising cotton swabs for analyte collection. The tablets would be placed into a plastic injection molded apparatus composed of a top and a base which were clipped together. The apparatus comprising the tablets would then be packaged into an aluminium lined, plastic, vacuum sealed membrane along with the swabs and heat sealed.

### Oxidising Agents

### Tablet Preparation

Sodium bisulphate (3.0 g) was milled to a fine powder, N,N′-diphenylbenzidine (0.3 g) added and the mixture further milled, methyl cellulose 4000 (0.5 g) added and the mixture further milled and stearic acid (0.35 g) added and the mixture further milled to provide a dry homogeneous powder.

Approximately 70-100 mg of powder was placed in a pill press and tablets of 5 mm diameter and 3 mm depth were prepared.

### Filter Paper Impregnation

A yellow solution of N,N′-diphenylbenzidine (0.05 g), sodium bisulphate (0.2 g) and stearic acid (0.2 g) in methanol (5 mL) was prepared and methylcellulose was added to provide a liquefied gel (approximately 0.3 g per 5 mL of solution). Filter paper (Whatman #1, 2, or 3) paper was dipped into the gel, the paper removed and immediately oven dried in the dark for 1 hr at 35° C.

The impregnated filter paper was immediately packaged in a light and moisture proof vacuum sealed flexible container.

The test kit whether prepared as a tablet or an impregnated filter paper is designed to give a positive reaction to most strong oxidising substances. Advantageously, compared to prior art kits, it does not contain the carcinogen diphenylamine.

N,N′-diphenylbenzidine is an effective redox indicator providing a colour change on oxidation. Without being limited by theory, it is believed that in the presence of an oxidising agent such as chlorate and an acid catalyst, the amine nitrogens undergo oxidation to provide imine and quinoidal compounds.

### Nitramines/Nitrates

### Tablet Preparation

Sodium bisulphate (1.5 g) was milled to a fine powder, sulfanilamide (0.3 g) added and the mixture further milled, N,N′-naphthyl ethylene diamine dihydrochloride (0.1 g) added and the mixture further milled, methyl cellulose 4000 (3.0 g) added and the mixture further milled, nano sized Zinc powder (0.2 g) added and the mixture further milled and stearic acid (1.0 g) added and the mixture further milled to provide a dry homogeneous powder.

Approximately 70-100 mg of powder was placed in a pill press and tablets of 5 mm diameter and 3 mm depth were prepared.

### Filter Paper Impregnation

Sodium bisulphate (0.5 g) was dissolved in a minimum volume of water (approximately 1 mL), sulfanilamide (0.2 g), N,N′-naphthyl ethylene diamine dihydrochloride (0.1 g) and nano sized Zinc powder (0.2 g) added and the solution shaken in the dark for 5 min. Methanol (4 mL) was added to the solution to provide a white slurry and methyl cellulose (0.3 g) added to provide a gel. Filter paper (Whatman #1, 2, or 3) was dipped into the gel, the paper removed and immediately oven dried in the dark for 1 hr at 35° C.

The impregnated filter paper was immediately packaged in a light and moisture proof vacuum sealed flexible container.

Without being limited by theory, it is believed that the zinc powder reducing agent in the presence of the sodium bisulphate acid catalyst reduces the nitro groups to nitrous acid. Nitrous acid may be detected with a Griess reagent, which is treated with the diazotizing agent sulfanilamide under acidic conditions forming a transient diazonium salt. This intermediate further reacts with the reagent N,N′-naphthylethylenediamine dihydrochloride to form a stabilised red/pink azo dye. It is believed the reaction will conceivably occur for nitroaromatics as well but due to the electron rich aromatic ring the process is greatly inhibited and for practical visualisation its use is impractical.

### Nitraromatics

### Tablet Preparation

Sodium hydroxide (1.0 g) was milled to a fine powder, calcium hydroxide (5.0 g) added and the mixture further milled and sodium lauryl sulphate (1.0 g) added and the mixture further milled to provide a dry homogeneous powder.

Approximately 70-100 mg of powder was placed in a pill press and tablets of 5 mm diameter and 3 mm depth were prepared.

### Filter Paper Impregnation

Sodium hydroxide (0.5 g) was dissolved in ethanol (5 mL) and the mixture shaken for 30 min after which time a gel had formed. Methyl cellulose was added and the mixture shaken for a further 1 hr. Filter paper (Whatman #1, 2, or 3) was dipped into the gel, the paper removed and immediately oven dried in the dark for 1 hr at 35° C.

The impregnated filter paper was immediately packaged in a light and moisture proof vacuum sealed flexible container.

Without being limited by theory, it is believed that the presence of a hydroxyl ion delocalises the mass of electrons within the aromatic ring, imparting a new charge structure within the whole molecule and to form a Meisenheimer Ion thereby providing a visual colour change. It is believed the presence of acetone and DMSO facilitate this process.

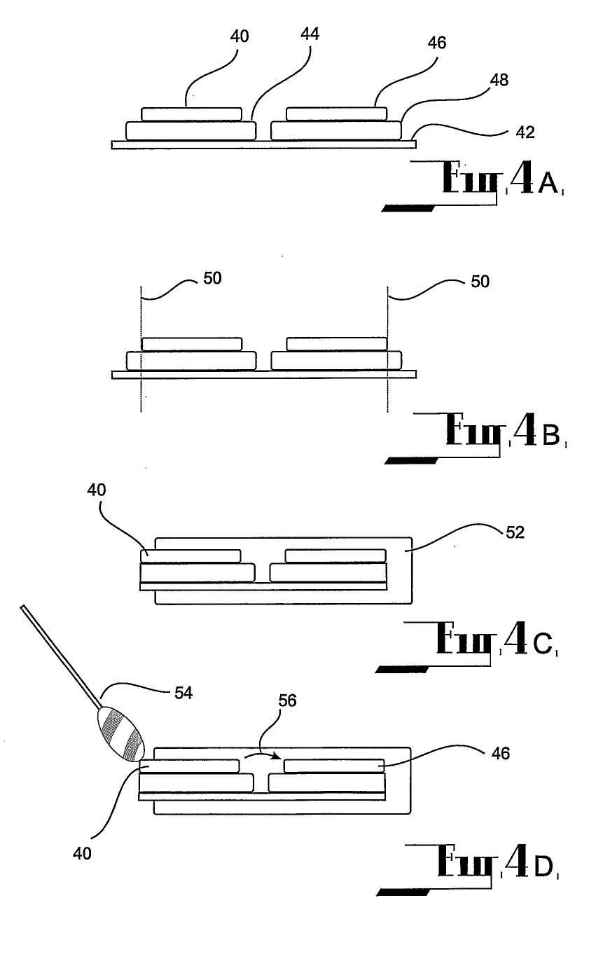

In general, at least one device will be packaged with a pre-wetted swab in an air tight flexible barrier packaging to provide a test kit 10, best seen in FIG. 3. To prepare a kit for testing for the presence of explosives and explosive residues, up to three devices in the form of tablets (not shown), for testing for oxidising agents 12, nitramines/nitrates 14 and nitroaromatics 16 are placed on a backing sheet 18 with recesses 20 for each tablet. The tablets sit proud on the backing sheet 18. A top sheet 22 with apertures 24 corresponding to each tablet is placed over the backing sheet 20 with the tablets sitting proud on the top sheet 22. The backing sheet 20 and the top sheet 22 clip together as shown in FIG. 2. A cover sheet 26 with rounded portions 28 corresponding to the tablets is placed over the top sheet 22. The sheets 20, 22, 26 containing the tablets are placed in first vacuum sealed compartment 30 adjacent a second vacuum sealed compartment 32 containing a swab 34 pre-wetted with DMSO to provide the finished kit 10.

To use the device, the kit 10 is preferably opened immediately prior to use, although unlike tests of the prior art, it is not essential that the device be used immediately upon opening. The swab 34 is removed from the kit 10 and wiped on the suspect residue or area and gently spotted, onto the tablets specific to oxidising agents, nitramines/nitrates and nitroaromatics. The detection of any colour change indicative of the analyte of interest will depend on many factors, including the analyte itself. It is expected that the device will be provided with information relating to the reaction times and colour changes expected for various analytes however, for full calorimetric identification, it is recommended that the user wait for two minutes before recording observations.

### Biologicals

### Tablet Preparation

Dimethyl amino cinnamaldehyde (0.01 g), sodium bisulphate (3.0 g), stearic acid (0.5 g), and methylcellulose (5 g), were milled to a fine dry homogeneous powder.

Approximately 70-100 mg of powder was placed in a pill press and tablets of 5 mm diameter and 3 mm depth were prepared.

### Filter Paper Impregnation

Dimethyl amino cinnamaldehyde (0.5 g) sodium bisulphate (1.5 g) and stearic acid (0.5 g) were dissolved in ethanol (10 mL) and the mixture mixed in the dark for 30 min. Filter paper (Whatman #1, 2, or 3) paper was dipped into the solution, the paper removed and immediately oven dried in the dark for 1 hr at 35° C.

The impregnated filter paper was immediately packaged in a light and moisture proof vacuum sealed flexible container.

### Ricin

### Filter Paper Impregnation

Sodium hydroxide (0.5 g) was dissolved in ethanol (5 mL) to provide a first solution and a pH indicator responsive to changes in the alkaline region of the pH spectrum (0.001 g) was dissolved in ethanol (5 mL) to provide a second solution. A first sample of filter paper (Whatman #1, 2, or 3) (5 mm×5 mm) was dipped into the first solution, the paper removed and immediately dried at 35° C. A second sample of filter paper (Whatman #1, 2, or 3) (5 mm×5 mm) was dipped into the second solution, the paper removed and immediately dried at 35° C. It should be appreciated that universal indicator paper may be used as an alternative to the second sample of filter paper.

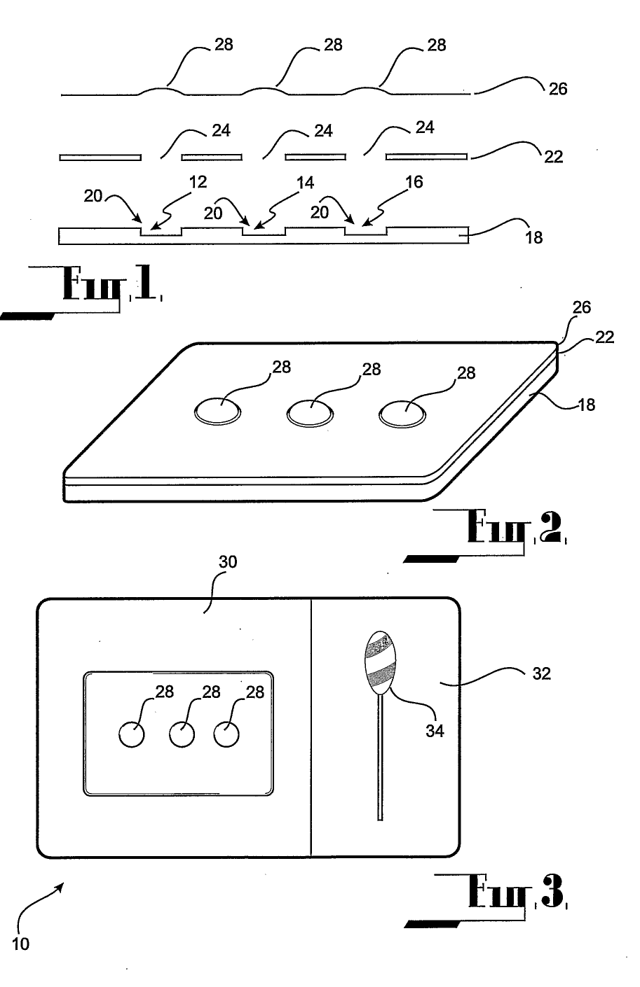

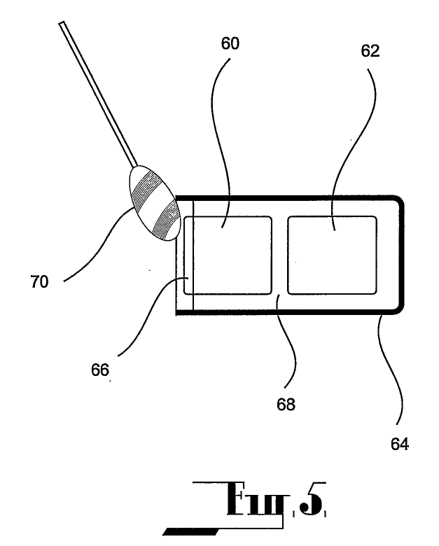

As shown in FIG. 4, the first sample of impregnated filter paper 40 was attached to a plastic backing strip 42 with double sided tape 44. The second sample of impregnated filter paper 46 was attached to the plastic backing strip 42 with double sided tape 48 adjacent the first sample of impregnated filter paper 40 with a gap of approximately 1 mm between the first and second samples of filter paper. The plastic backing strip 42 was cut adjacent the edges of the filter papers 40, 46 along the dotted lines 50 shown in Step 2 of FIG. 1. The plastic backing strip 42 and filter papers 40, 46 were enclosed in a heat sealed, inert, plastic envelope 52 exposing a small portion of the sodium hydroxide impregnated filter paper 40 as shown in Step 3.

In use, the user (not shown) applies a water swabbed sample of the analyte onto the exposed portion of the filter paper 40 with the swab 54. The water swabbed sample if containing ricin residue will contain the ricinine molecule, which is used in forensic identification as a biomarker for ricin. The ricinine molecule contains a cyano or nitrile group which is converted into ammonia under highly alkaline conditions. It is believed that few natural products contain such a cyano functional group and so the test is quite unlikely to exhibit a false positive. The evolved ammonia travels 56 from the alkaline strips to the pH strip causing a colorimetric indication on the filter paper 46.

### Alcohol

### Filter Paper Impregnation

Sodium bisulphate (0.5 g) and potassium dichromate (0.2 g) were dissolved in deionised water (5 mL) to provide a first solution and sodium nitroprusside (0.13 g), sodium bicarbonate (0.1 g) and proline (0.02 g) were dissolved in deionised water (3 mL) to provide a second solution. A first sample of filter paper (Whatman GFC glass fibre) was dipped into the first solution, the paper removed and immediately dried at 35° C. overnight. A second sample of filter paper (Whatman #1, 2, or 3) was dipped into the second solution, the paper removed and immediately dried at 35° C.

Drying and bulking agents may be added to the second solution to provide an uneven surface on the second sample of filter paper on drying. Such a surface is believed to enhance the reactive surface area of the second sample of filter paper, thereby increasing the rate and sensitivity of the colorimetric reaction.

As shown in FIG. 5, the first sample of impregnated filter paper 60 and the second sample of impregnated filter paper 62 were placed between thin strips of heat sealable plastic membrane 64 and three sides of the membrane sealed, leaving the tip 66 of the first sample of impregnated filter paper 60 exposed for swab 70 application. A gap 68 of approximately 2 mm is provided between filter paper 60 and filter paper 62.

The heat sealed plastic membrane 64 may be provided in the form plastic sleeve for protection.

Where ethanol is present, it is oxidised by potassium dichromate in the presence of sodium bisulphate to give acetaldehyde. The latter may be detected in vapour phase through the blue colour it produces when it comes into contact with sodium nitroprusside and most secondary aliphatic amines. In the present invention, in order to maintain a dry pack device, the secondary amine proline (2-pyrrolidinecarboxylic acid) was chosen as it exists naturally as a dry anhydrous powder.

The test is sensitive and accurate for ethanol (acetaldehyde) detection, as firstly the ethanol is converted to gaseous acetaldehyde within the first sample of impregnated filter paper 60. As the first sample of impregnated filter paper 60 and the second sample of impregnated filter paper 62 do not touch, only vapour phase analyte (acetaldehyde) can reach the second sample of impregnated filter paper 62.

Secondly, in general the other alcohol of concern is methanol which would ordinarily be oxidized to give formaldehyde which does not react with the reagents in strip B.

The chance of false positives is very low as the presence of methanol will not give a false positive for ethanol. Oxidation of methanol forms formaldehyde which will not provide a colorimetric indication in the presence of sodium nitroprusside, sodium bicarbonate and proline.

In use, the user (not shown) immerses a dry cotton swab into any fluid, saliva, beverage sample of interest and the wetted swab applied onto the exposed portion of the filter paper 30 until the filter paper is wetted, at which time, the swab is removed. If ethanol is present in the sample, it is oxidised to acetaldehyde and the evolved acetaldehyde travels 64 from the filter paper 60 to the filter paper 62 causing a colorimetric indication on the filter paper 62, turning filter paper 62 from white to dark blue.

Alternatively, the exposed portion of the filter paper 60 may be inserted directly into the sample or placed into the mouth of a user suspected of consuming ethanol.

### Trials

A 1 mgmL⁻¹ stock solution of each explosive analyte was prepared by dissolving. Nitro-aromatic material (m-dinitrobenzene) in chloroform, nitramine material (RDX) in acetone and nitrate (KNO₃) and chlorate (KClO₃) materials in water. Peroxide was used as a 1% (w/v) solution.

A Hamilton micro-pipette was used to apply a known micro-litre (μL) volume of each analyte stock solution to the surface of a clean white tile. The solvent was evaporated under a stream of air, leaving explosive residue of known micro-gram (μg) mass on the tile surface.

A swab wetted with DMSO/acetone was wiped over the relevant explosive residue to maximise removal of the residue from the tile. The swab was gently spotted for 1 s onto the surface of the respective tablet.

For the tests involving peroxide solutions, the solution was applied directly to the tablet surface.

Chlorates are considered to be the most difficult residues to detect, requiring the greatest amount of time for detection. Although quantities in the order of 10 μg or less are detectable, the time frame within which such an indication becomes visibly discernable (e.g. +5 min) is considered to be ambiguous in relation to the times for indication produced by tests for nitroaromatics and nitrates which are less than 5 s.

It is considered that due to the nature of the device of the present invention, its scenario of application i.e. rapid in-situ presumptive test, that a time constraint of 2 min be placed on operator observation of the chlorate test for a positive indication. Consequently, it is considered that the limit of detection for the chlorate tests, based on the above constraints, be in the order of 30 μg. Notwithstanding this limitation, tests have shown that the device of the present invention may be used to detect the presence of chlorates at 4 μg, providing a blue/green colour change in approximately 1 minute.

Peroxides were shown to react in significantly less time. The limit of detection is considered to be in the order of 15 μg.

The colorimetric indication of both chlorate and peroxides with N,N′-diphenylbenzidine was deep blue/green and permanent.

Nitrates reacted slower than nitramines although a discernable indication was achieved within 5 sec and the limit of detection for both species was considered to be in the order of 1 μg.

The colorimetric indication of both nitrate and nitramine was red and temporary, lasting several minutes.

Nitroaromatics produced a discernable indication almost instantaneously, providing a pink/purple colour change on both the tablet surface and swab tip and the limit of detection was considered to be in the order of <1 ug.

TABLE 1

| | | | |
|---|---|---|---|
| | | Nitramine/ | Chlorate/ |
| | Nitroaromatic | Nitrate | Peroxide |
| Residue | Test | Test | Test |

Household

| | | | |
|---|---|---|---|
| Cleaning agents | X | X | X |
| Detergents | X | X | X |
| Concentrated Bleach | X | — | ✓ |

Foodstuff

| | | | |
|---|---|---|---|
| Carbonated | X | X | X |
| alcoholic drink | | | |
| Wine | X | X | X |
| Carbonated | X | X | X |
| non-alcoholic drink | | | |
| Milk | X | X | X |
| Fruit juice | X | X | X |
| Chocolate | X | X | X |
| Flour | X | X | X |
| Sugar | X | X | X |
| Salt | X | X | X |

Cosmetic

| | | | |
|---|---|---|---|
| Body cream | X | X | X |
| Deodorant | X | X | X |
| Hair bleach | X | X | ✓ |
| Talc powder | X | X | X |

Industrial

| | | | |
|---|---|---|---|
| WD40 | X | X | X |
| Lens cleaner | X | X | X |

Agricultural

| | | | |
|---|---|---|---|
| Nitrate fertiliser | X | ✓ | X |

Miscellaneous

| | | | |
|---|---|---|---|
| Whiteboard marker dye | X | — | X |
| Painted surfaces | X | X | X |
| Lacquered surfaces | X | X | X |
| Shoe polish | X | X | X |
| Skin exudate | X | X | X |
| Plastic | X | X | X |
| Car interior polish | X | X | X |
| Car exterior polish | X | X | X |

Investigations on common household chemicals were conducted to consider the likelihood of such chemicals causing false positives and are shown above in Table 1.

Biological samples produced a discernable blue purple or red positive indication for the presence of proteinaceous, peptidoglycan (e.g. N-acetylglucosamine, N-acetylmuramic acid) material. Tests were conducted on residues including dry and wet bacterial cultures, human skin and plant residues. The analyte was sampled with either a water swab or 50:50 water/ethanol swab, by wiping the residue surface with the swab and then wiping the swab onto the device. Colorimetric indications were observed within two minutes.

Tests on samples comprising ethanol displayed a concentration dependence. Samples containing 10% (w/v) gave positive results within 15 seconds, whilst 1% (w/v) samples took up to 5 minutes to provide a full colorimetric response. Saliva is believed to inhibit the oxidation of ethanol to acetaldehyde, increasing response time by up to 10 minutes.

1. A device for testing for the presence of an analyte, the device comprising at least one reagent adapted to provide a calorimetric indication in the presence of the analyte, a catalyst to catalyse the reaction providing the colorimetric indication, and where there is provided one reagent, an inhibitor for substantially inhibiting reaction between reagent and catalyst or where there is provided more than one reagent, an inhibitor for substantially inhibiting reaction between said reagents and between said reagents and catalyst, prior to introduction of the analyte, wherein the at least one reagent and the catalyst are solids.

2. A device for testing for the presence of an analyte according to claim 1, wherein the device is provided in the form of a pressed article such as a tablet or at least one dry coated solid support upon which the colorimetric reaction can take place.

3. A device for testing for the presence of an analyte according to claim 2, wherein the solid support is provided in the form of paper, fabric, plastic, silicates, alumina based products or wood.

4. A device for testing for the presence of an analyte according to claim 2, wherein the solid support is provided in the form of normal or reverse phase filter paper, glass and ceramic fibre paper, nylon, cotton or rayon.

5. A device for testing for the presence of an analyte according to claim 1, wherein the inhibitor for substantially inhibiting the reaction between reagent and catalyst or where there is provided more than one reagent, between said reagents and between said reagents and catalyst, prior to introduction of the analyte provides physical separation of each reagent from each other and/or the or each reagent and the catalyst.

6. A device for testing for the presence of an analyte according to claim 5, wherein the physical separation comprises the use of more than one dry impregnated bibulous carrier wherein the at least one reagent and the catalyst are provided on different impregnated bibulous carriers.

7. A device for testing for the presence of an analyte according to claim 6, wherein the dry impregnated bibulous carriers are aligned end to end to provide a consecutive lateral flow sequence or overlaid one on top of another in a sandwich fashion, such that separation of said reagents and catalysts is maintained until the application of the analyte.

8. A device for testing for the presence of an analyte according to claim 5, wherein the physical separation comprises providing the solid support in the form of a crystalline lattice, such that the distribution of the at least one reagent and the catalyst amongst the lattice interstices substantially inhibits their reaction.

9. A device for testing for the presence of an analyte according to claim 8, wherein the device comprises an encapsulating substance that substantially separately encapsulates the or each reagent and the catalyst.

10. A device for testing for the presence of an analyte according to claim 5, wherein the physical separation is provided in the form of an encapsulating substance that substantially separately encapsulates each reagent and the catalyst, thereby substantially preventing reaction.

11. A device for testing for the presence of an analyte according to claim 10, wherein the encapsulating substance is selected from the group comprising polyvinyl alcohol, polyvinyl pyrollidinone, acrylics, styrene, vinyl chloride, natural gums, gelatine, and waxes of various chain lengths and their salts.

12. A device for testing for the presence of an analyte according to claim 10, wherein the encapsulating substance is selected from the group comprising stearic acid and magnesium stearate.

13. A device for testing for the presence of an analyte according to claim 1, wherein the device comprises agents adapted to reduce UV degradation such as micronised zinc and titanium oxides, octyl-methoxycinnamate, butyl methoxydibenzoylmethane and octyl-salicylate.

14. A device for testing for the presence of an analyte according to claim 1, wherein the device comprises an introducer for introducing the analyte to at least one reagent.

15. A device for testing for the presence of an analyte according to claim 14, wherein the introducer for introducing the analyte to at least one reagent is provided in the form of a swab.

16. A device for testing for the presence of an analyte according to claim 15, wherein the swab is composed of adsorbent materials such as cotton or rayon.

17. A device for testing for the presence of an analyte according to claim 15, wherein the swab is dry or comprises a solvent that will assist in the transfer of the analyte to the device such as water, alcohol or other organic solvents.

18. A device for testing for the presence of an analyte according to claim 17, wherein the swab comprises more than one solvent.

19. A device for testing for the presence of an analyte according to claim 17, wherein the encapsulating substance is soluble in the solvent.

20. A device for testing for the presence of an analyte according to claim 17, wherein the encapsulating substance is stearic acid and the solvent is dimethylsulfoxide.

21. A device for testing for the presence of an analyte according to claim 1, wherein the device comprises a substantially inert dry chemical with detergent properties adapted to enhance the mixing of the analyte with the at least one reagent.

22. A device for testing for the presence of an analyte according to claim 21, wherein the substantially inert dry chemical is provided in the form of sodium lauryl sulfate.

23. A device for testing for the presence of an analyte according to claim 1, wherein the device comprises a bulking agent.

24. A device for testing for the presence of an analyte according to claim 23, wherein the bulking agent is selected from the group comprising sodium lauryl sulfate, sulfated primary alcohols, methyl cellulose, carboy methyl cellulose and natural inert gums.

25. A device for testing for the presence of an analyte according to claim 1, wherein the device is stored in a moisture and UV resistant package prior to use.

26. A device for testing for the presence of an analyte according to claim 1, wherein the device comprises desiccants to inhibit the ingress of moisture.

27. A device for testing for the presence of an analyte according to claim 1, wherein the device comprises a drying agent adapted to inhibit ingress of water.

28. A device for testing for the presence of an analyte according to claim 27, wherein the drying agent is selected from the group comprising anhydrous sodium sulfate, methylcellulose and calcium hydroxide.

29. A device for testing for the presence of an analyte according to any claim 1, wherein the device is adapted to detect the presence of explosives and explosive residues, materials composed of proteinaceous residues and fingerprint functional groups as biomarkers of biological agents and/or alcohols.

30. A device for testing for the presence of an analyte according to claim 29, wherein the explosives and explosive residues are selected from the group comprising nitramines, nitrates, nitrate esters, nitroaromatics and oxidising agents such as chlorates, bromates, iodates and peroxides.

31. A device for testing for the presence of an analyte according to claim 30, wherein the analyte is a nitramine or a nitrate and the reagent is selected from the group comprising analine sulfate, barium chloride, brucine, cupric-tetrapyridine, diphenylamine, griess reagent, J-Acid, K-Acid, I-Acid, Nitron, mercuric chloride, methylene blue, silver nitrate, dithiocarbamate, thymol blue, anthranilic acid, alphanaphthylamine, sulphanilic acid, sulphanilamide, p-aminobenzoic acid, N-(1-naphthyl)ethylenediamine dihydrochloride, sodium arsenite, picric acid, p-anisidine, o-anisidine, diphenylhydrazine, dimethylaminobenzaldehyde, diethylaminobenzaldehyde, dimethylamino cinnamaldehyde and sodium salicylate.

32. A device for testing for the presence of an analyte according to claim 30, wherein the analyte is a nitroaromatic and the reagent is selected from the group comprising potassium hydroxide, calcium hydroxide, tetra-alkyl ammonium hydroxide, sodium hydroxide and diphenylamine.

33. A device for testing for the presence of an analyte according to claim 30, wherein the analyte is an oxidising agent such as chlorate, bromate, iodate and peroxide and the reagent is selected from the group comprising indigo carmine, N,N′-diphenylbenzidine, phenylanthranilic acid, methylene blue, potassium iodide, aniline hydrochloride, aniline sulfate, aniline acetate, aniline nitrate, brucine sulfate, J-Acid, K-Acid, ammoniumthiocyanate, zinc chloride, thiodene, fluorescein, potassium iodide, potassium bromide, safranin, thallous hydroxide, manganous sulfate, diphenylamine, o-toluidine, ferrous thiocyanate N,N-diethyl-1,4-phenylene diamine sulfate, ferroin (aqueous solution of ferrous sulfate heptahydrate and 1,10 phenanthroline monohydrate), diphenylamine-4-sulfonic acid barium salt and cresyl violet acetate (9-amino-5-imino-5H-benzo(a) phenoxazine.

34. A device for testing for the presence of an analyte according to claim 30, wherein the analyte is a proteinaceous residue or a fingerprint functional group as a biomarker of a biological agent and the reagent is selected from the group comprising dimethylaminobenzaldehyde, diethylaminobenzaldehyde, dimethylaminocinnamaldehyde, p-hydroxydiphenyl, anthrone, ninhydrin, lowery, bradford, BCA/biuret and coomassie blue reagents, methylene violet, crystal violet, safranine, acid black, 1,8-diaza-9-fluorenone, 1,2-indanedione, gentian violet, sudan black, rhodamine 6 g, safranin o, nile red, acid fuschin, genipin.

35. A device for testing for the presence of an analyte according to claim 30, wherein the analyte is ricin and the biomarker for ricin is ricinine and the reagent is selected from the group comprising universal indicator, thymol blue, metacresol purple, bromocresol purple, chlorophenol red, p nitrophenol, Alizarin, bromothymol blue, brilliant yellow, phenol red, neutral red, m-nitrophenol, cresol red, curcumin, metacresol purple, bromocresol red, rosalic acid, quinoline blue, resorcin blue, alizarin red s and methyl red.

36. A device for testing for the presence of an analyte according to claim 30, wherein the analyte is an alcohol such as ethanol and the reagent is selected from the group comprising vanadium oxinate, nitratocerate, 4-(phenylazo)phenylhydrazinosulfonic acid, nitrophenylhydrazine, fuschin, malachite green, sodium nitroprusside, proline, o-dianisidine, p hydroxydiphenyl, o-hydroxydiphenyl, ceric ammonium nitrate, m phenylenediamine hydrochloride, hydroquinone and sulfanilic acid and any secondary aliphatic amine.

37. A device for testing for the presence of an analyte according to claim 1, wherein the catalyst is an acid catalyst, an alkaline catalyst or an oxidising agent, the choice of catalyst depending on the colorimetric reaction.

38. A device for testing for the presence of an analyte according to claim 37, wherein the catalyst is an acid catalyst selected from the group comprising sodium bisulphate, ammonium bisulphate, trichloroacetic acid, trifluoroacetic acid, oxalic acid, citric acid, tartaric acid, ammonium chloride, sulphuric acid and phosphoric acid.

39. A device for testing for the presence of an analyte according to claim 37, wherein the catalyst is an alkaline catalyst selected from the group comprising sodium hydroxide, potassium hydroxide, calcium hydroxide, tetra-alkylammonium hydroxide and diphenylamine.

40. A device for testing for the presence of an analyte according to claim 37, wherein the analyte is an alcohol such as ethanol and the catalyst is an oxidising agent selected from the group comprising potassium dichromate and potassium permanganate.

41. A device for testing for the presence of an analyte according to claim 30, wherein the analyte is a nitramine or a nitrate and the device comprises a reducing agent.

42. A device for testing for the presence of an analyte according to claim 41, wherein the reducing agent is selected from the group comprising nano-sized zinc powder, thiosulphate salts, metabisulphite salts, ascorbic acid, stannous chloride, titanium trichloride, copperised-cadmium and ferrous sulfate.

43. A method for preparing a device for testing for the presence of an analyte, the method comprising the steps of:
mixing at least one reagent adapted to provide a colorimetric indication in the presence of the analyte, a catalyst to catalyse the reaction providing the colorimetric indication and an encapsulating substance adapted to substantially inhibit reaction between reagent and catalyst where there is provided one reagent or where there is provided more than one reagent, between said reagents and between said reagents and catalyst, prior to introduction of the analyte, wherein the at least one reagent, the catalyst and the encapsulating substance are solids to provide a solid mixture; and
forming said mixture into a pressed article.

44. A method for preparing a device for testing for the presence of an analyte according to claim 43, wherein the method comprises the step of:
milling the at least one reagent, the catalyst and the encapsulating substance prior to the step of pressing said mixture into a tablet.

45. A method for preparing a device for testing for the presence of an analyte according to claim 43, wherein the step of milling the at least one reagent, the catalyst and the encapsulating substance prior to the step of pressing said mixture into a tablet comprises the step of:
milling the at least one reagent, the catalyst and the encapsulating substance separately prior to forming the mixture.

46. A method for preparing a device for testing for the presence of an analyte, the method comprising the steps of:
suspending or dissolving at least one reagent adapted to provide a calorimetric indication in the presence of the analyte, a catalyst to catalyse the reaction providing the colorimetric indication, and an encapsulating substance adapted to substantially inhibit reaction between reagent and catalyst where there is provided one reagent or where there is provided more than one reagent, between said reagents and between said reagents and catalyst, prior to introduction of the analyte, in a non-aqueous solvent;
introducing a solid support article into the non-aqueous solvent, and
removing the solid support and drying the solid support, thereby producing a device in the form of a dry reagent-coated article.

47. A method for preparing a device for testing for the presence of an analyte according to claim 46, wherein the non-aqueous solvent is selected from the group comprising chloroform, acetone, ether and ethyl acetate.

48. A method for preparing a device for testing for the presence of an analyte according to claim 46, wherein the solid support article is provided in the form of paper, plastic or wood.

49. A method for preparing a device for testing for the presence of an analyte, the method comprising the steps of:
suspending or dissolving at least one reagent adapted to provide a calorimetric indication in the presence of the analyte in a first solvent to provide a first solution;
introducing a first solid support article into said first solution;
removing said first solid support and drying first solid support, thereby producing a reagent-coated article;
suspending or dissolving a catalyst adapted to catalyse the reaction providing the colorimetric indication in a second solvent to provide a second solution;
introducing a second solid support article into said second solution, removing said second solid support and drying second solid support, thereby producing a catalyst-coated article;
attaching the reagent-coated article and the catalyst-coated article to a support such that the reagent-coated article and the catalyst-coated article are not touching each other; and
coating the support, the reagent-coated article and the catalyst-coated article with a moisture resistant coating such that a portion of the catalyst coated article is exposed to the atmosphere.

50. A method for preparing a device for testing for the presence of an analyte according to claim 49, wherein the reagent is provided in the form of a pH indicator.

51. A method for preparing a device for testing for the presence of an analyte according to claim 49, wherein the method comprises the further step of:
reducing exposure of the at least one reagent, the first solvent, the catalyst, and the second solvent to light.

52. A method for preparing a device for testing for the presence of an analyte according to claim 49, wherein the method comprises the further step of:
reducing exposure of the at least one reagent, the first solvent, the catalyst, and the second solvent to moisture.

53. A method for preparing a device for testing for the presence of an analyte according to claim 43, wherein the method comprises the further step of:
reducing exposure of the at least one reagent, the catalyst, and the encapsulating substance to light.

54. A method for preparing a device for testing for the presence of an analyte according to claim 43, wherein the method comprises the further step of:
reducing exposure of the at least one reagent, the catalyst, and the encapsulating substance to moisture.

55. A method for preparing a device for testing for the presence of an analyte according to claim 43, wherein the at least one reagent, the catalyst and the encapsulating substance are dried before use.

56. A method for preparing a device for testing for the presence of an analyte according to claim 43, wherein the method comprises the further step of:
packaging the device in a moisture and UV resistant package.

57. A method for preparing a device for testing for the presence of an analyte according to claim 56, wherein the method comprises the further step of:
packaging the device in the presence of an inert atmosphere.

58. A method for using a device for testing for the presence of an analyte, the method comprising the steps of:
transferring an analyte from a surface to the device;
rubbing the analyte onto the surface of the device
thereby facilitating a calorimetric reaction between at least one reagent and the analyte, wherein the device comprises at least one reagent adapted to provide a colorimetric indication in the presence of the analyte, a catalyst to catalyse the reaction providing the colorimetric indication, and where there is provided one reagent, an inhibitor for substantially inhibiting reaction between reagent and catalyst or where there is provided more than one reagent, an inhibitor for substantially inhibiting reaction between said reagents and between said reagents and catalyst, prior to introduction of the analyte, wherein the at least one reagent and the catalyst are solids.

59. A method for using a device for testing for the presence of an analyte according to claim 58, wherein the step of transferring the analyte from a surface to the device comprises the steps of:
rubbing the surface with a swab, thereby transferring at least a portion of the analyte from the surface to the swab; and
rubbing the swab onto the surface of the device, thereby transferring the analyte onto the device.

60. A method for using a device for testing for the presence of an analyte according to claim 59, wherein the swab comprises a solvent that will assist in the transfer of the analyte to the device such as water, alcohols or other organic solvents.

61. A method for using a device for testing for the presence of an analyte according to claim 58, wherein the inhibitor for substantially inhibiting reaction between reagent and catalyst or where there is provided more than one reagent, the inhibitor for substantially inhibiting reaction between said reagents and between said reagents and catalyst is provided in the form of an encapsulating substance and the encapsulating substance is soluble in the solvent.

62. A method for using a device for testing for the presence of an analyte according to claim 58, wherein the step of rubbing the swab onto the surface of the device, thereby transferring the analyte onto the device, removes the inhibitor, thereby exposing reagent and catalyst to collected sample thus enabling reaction of the analyte with the reagent.

63. A method for using a device for testing for the presence of an analyte, wherein the device comprises at least one solid reagent adapted to provide a colorimetric indication in the presence of the analyte on a first solid support article, a catalyst to catalyse the reaction providing the colorimetric indication on a second solid support article wherein the reagent coated article and the catalyst coated article are attached to a support such that the reagent coated article and the catalyst coated article are not touching each other and the support and the reagent coated article and the catalyst coated article are coated with a moisture resistant coating such that a portion of the catalyst coated article is exposed to the atmosphere, the method comprising the steps of:
transferring the analyte from a surface to the atmosphere exposed portion of the catalyst coated article of the device;
rubbing the analyte onto said exposed portion of the surface of the device,
thereby facilitating a reaction between the analyte and the catalyst to produce a product whereby said product reacts with the at least one reagent to provide a colorimetric indication.

64. A method for using a device for testing for the presence of an analyte according to claim 63, wherein the step of transferring the analyte from a surface to the device comprises the steps of:
rubbing the surface with a swab, thereby transferring at least a portion of the analyte from the surface to the swab; and
rubbing the swab onto the exposed portion of the surface of the device, thereby transferring the analyte onto the device.

65. A method for using a device for testing for the presence of an analyte according to claim 64, wherein the swab comprises a solvent that will assist in the transfer of the analyte to the device such as water, alcohols or other organic solvents.

66. (canceled)

67. (canceled)

68. (canceled)

69. (canceled)
